(19) United States
(12) Patent Application Publication
(10) Pub. No.: US 2025/0350996 A1
(43) Pub. Date: Nov. 13, 2025

(54) METHODS AND APPARATUS FOR BI-STATIC PROXIMITY DETERMINATION

(71) Applicant: APPLE INC., Cupertino, CA (US)

(72) Inventors: Ankit Bhamri, Bad Nauheim (DE); Huaning Niu, San Jose, CA (US); Wei Zeng, Saratoga, CA (US); Haitong Sun, Cupertino, CA (US); Hong He, Cupertino, CA (US); Chunxuan Ye, San Diego, CA (US); Dawei Zhang, Saratoga, CA (US); Rolando E. Bettancourt Ortega, Munich (DE)

(21) Appl. No.: 19/201,555

(22) Filed: May 7, 2025

Related U.S. Application Data
(60) Provisional application No. 63/644,895, filed on May 9, 2024.

(51) Int. Cl. H04W 28/02; H04L 67/12

(52) U.S. Cl. CPC H04W 28/0268; H04L 67/12

(57) ABSTRACT

Systems and methods for bi-static proximity determination are discussed herein. Additionally, proximity determination for ambient internet of things (IoT) devices for Topology 2 and signaling for intermediate user equipment (UE) for ambient IoT device communication are discussed herein. For example, an intermediate UE receives, from a network node, a reader-to-device (R2D) data repetition configuration. The intermediate UE receives, from the network node, R2D data for forwarding to an ambient IoT device. The intermediate UE transmits the R2D data to the ambient IoT device, and transmits one or more R2D data repetitions of the R2D data to the ambient IoT device, based on the R2D data repetition configuration. In some cases, a network node may transmit to an intermediate UE a R2D data repetition configuration, and transmit to the intermediate UE R2D data to be forwarded to an ambient IoT device based on the R2D data repetition configuration.

### TECHNICAL FIELD

This application relates generally to wireless communication systems, including the implementation of ambient internet of things (IoT) device communication.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a scenario encountered for Topology 1 in accordance with some embodiments.

FIG. 1B illustrates a scenario encountered for Topology 2 in accordance with some embodiments.

FIG. 2 illustrates an example of Topology 2 in accordance with some embodiments.

FIG. 3 illustrates a flow diagram of a selection procedure to determine intermediate UE(s) for communication with an ambient IoT device, according to embodiments herein.

FIG. 4 illustrates an example of a repetition procedure where only a next repetition is performed after a response is not received, according to embodiments herein.

FIG. 5 illustrates an example of a repetition procedure where multiple repetitions are performed after a response is not received, according to embodiments herein.

FIG. 6 illustrates an example of a repetition procedure where the repetitions are performed independent of whether a response is received or not, from an ambient IoT device, according to embodiments herein.

FIG. 7 illustrates a method for an intermediate UE, according to embodiments herein.

FIG. 8 illustrates a method for a network node, according to embodiments herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

It should be understood that various issues may be encountered while undergoing communication with ambient IoT devices in Topology 2 where an intermediate node (e.g., an intermediate UE) may be deployed to communicate with the ambient IoT device(s), where the intermediate node is under the control of/configured by network (e.g., the network may communicate to the intermediate node on how, when, and what to communicate with the ambient IoT device).

In some wireless communication systems, various device definitions have been agreed upon. For example, a first device, “Device 1”, may have around one microwatt (μW) peak power consumption, may have energy storage, an initial sampling frequency offset (SFO) of up to 10× parts per million (ppm) where X is a multiplier (e.g., in a range of 4-5), with neither downlink (DL) nor uplink (UL) amplification in the device. Further, the device's UL transmission may be backscattered on a carrier wave provided externally.

A second device, “Device 2a” may have less than or equal to a few hundred μW peak power consumption, may have energy storage, may have an initial SFO of up to 10× ppm where X is a multiplier (e.g., in a range of 3-4), and both DL and/or UL amplification may be in the device. Further, the device's UL transmission may be backscattered on a carrier wave provided externally.

A third device, “Device 2b” may have less than or equal to a few hundred μW peak power consumption, may have energy storage, may have an initial SFO of up to 10× ppm where X is a multiplier (e.g., in a range of 3-4), and both DL and/or UL amplification in the device. Further, the device's UL transmission may be generated internally by the device.

In some wireless communication mechanisms, it was agreed to support Topology 2 (e.g., a two-hop communication between the base station and ambient IoT device via an intermediate UE). Support of Topology 2 may assume that (in a second deployment scenario with Topology 2 with an intermediate UE configured by the network), the base station may have various coexistence characteristics (e.g., Macro-cell and co-site characteristics). Note that the location of the intermediate node (e.g., intermediate UE) may encompass both indoor and outdoor scenarios.

Additionally, in some wireless communication systems, various scenarios have been contemplated. Note scenarios under the set D2T may encompass 2-hop communication including intermediate UE(s) as the reader (illustrated as “R” or reader) that may directly communicate with the ambient IoT device (illustrated as “D” or device) (where the intermediate UE is configured by the network). The communication between the base station and intermediate UE (the intermediate UE being a reader) is expected to be done via one or more Uu interfaces. In some scenarios, a carrier wave (CW) node (“CW” as illustrated) may be expected to provide the carrier wave node for various backscattering device types (e.g., devices that do not have active an UL or D2R transmission (Tx)), but may be UL or D2R based for the backscattering of the carrier wave that it receives from the CW node.

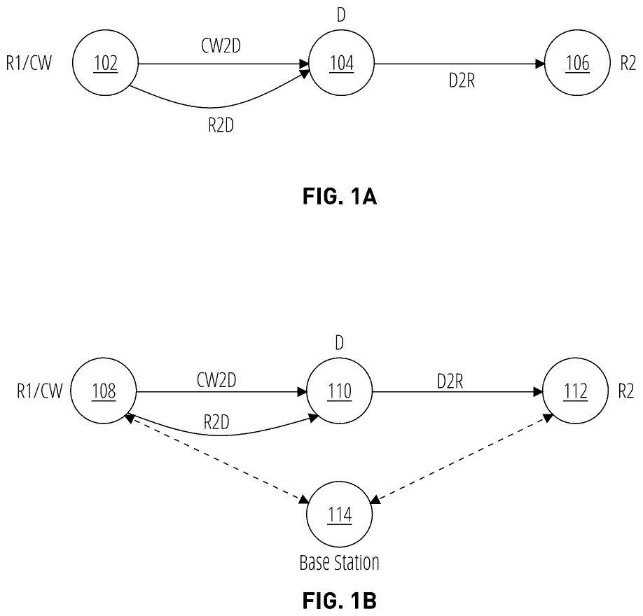

FIG. 1A illustrates a scenario encountered for Topology 1. As illustrated in FIG. 1A, a scenario for Topology 1 (DIT1-A1), may include a first reader and/or CW node 102, a device 104 and a second reader 112 (the CW node may be included this scenario). The first reader and/or CW node 102 may forward information to/communicate with the device 104 via carrier wave-to-device (CW2D) communication or via reader-to-device (R2D) communication, based on if the first reader and/or CW node 102 is a reader node (e.g., an intermediate UE) or a CW node. It should be understood that the reader node may encompass an intermediate UE. The CW node and the second reader 106, “R2”, may be different while the CW node and the first reader, “R1”, may be the same. Note that the first reader, “R1”, and the second reader, “R2” are different. In some instances, the device 104 may communicate with the second reader 106 via device-to-reader (D2R) communication.

FIG. 1B illustrates a scenario encountered for Topology 2. As illustrated in FIG. 1B, a scenario for Topology 2 (D2T2-A1, generally known as bistatic backscattering) may include a first reader or CW node 108, a device 110, a second reader 112, and a base station 114 (the CW node may be included this scenario). In the illustrated scenario, the first reader or CW node 108 may forward information to and/or communicate with the device 110 via CW2D communication or via reader-to-device (R2D communication), based on if the first reader or CW node 108 is a reader node (intermediate UE) or a CW node. It should be understood that the reader node may encompass an intermediate UE. The “CW” in CW2D and the “R2” in DER are different, however, the “CW” in CW2D and the “R1” in R2D may be the same. Additionally, the “R1” in R2D and the “R2” in D2R may be different. In some instances, the device 110 may communicate to the second reader 112 via D2R communication. The base station 114 may signal to the first reader or CW node 108 or the second reader 112 but may not communicate with the device 110 as the first reader or CW node 108 or the second reader 112 communicate with the device 110/forward data from the base station 114 to the device 110.

In some wireless communication systems, proximity determination of the ambient internet of things (IoT) device(s) may be considered. Various aspects have been agreed upon in 3GPP related to proximity determination. For example, proximity determination based on device side measurements may not be considered. Further, it may be beneficial to clarify that a proximity determination may be used to determine whether the ambient IoT device is close (e.g., “near”) to the reader (e.g., base station or intermediate UE).

Note that in some wireless communication mechanisms various issues encountered for the proximity determination in case of Topology 2 wherein an intermediate UE (under network control) is serving the ambient IoT device may apply to both Topology 2 and Topology 1. For example, issue encountered may include how does the network determine which UEs may be utilized for communication with ambient IoT device based on proximity determination, how does the intermediate UE determines the proximity of one or multiple ambient IoT devices, and how does the intermediate UE inform the network on whether and what ambient IoT devices are in its proximity and whether it can serve those devices.

Additionally various problems may be considered for proximity determination in scenarios where the ambient IoT device is receiving from one reader, but transmitting to another reader, considering that no device side measurements are allowed based on various agreements previously made for proximity determination. For example, problems may include when to determine the device as “near” in case of bistatic proximity determination. It may not be clear how to determine the proximity of the ambient IoT device relative to the transmit reader considering no device-side measurements are performed. Further, it is not clear how to determine when a different transmit reader and receive reader are configured based on a proximity determination.

In various embodiments, an ambient IoT device may be determined as “near” for communicating with configured nodes (e.g., CW node or intermediate UE) based on various cases when there are different transmit reader(s) and receive reader(s).

In some cases, for responding when an ambient IoT device is determined as “near,” the ambient IoT device may be determined as “end-to-end near” if the response from the device is received at the receive reader. During contention-based access, successful reception may be used as criteria. Further, during contention-free access, the reception may or may not be successful. Alternatively, the device may be determined as “R2D near,” but not “D2R near” if the response from the device is received at the receive reader on the scheduled resources, but not unsuccessfully. Alternatively, the device may be determined as “end-to-end not near,” if there is no response from the device at the receive reader on the scheduled resources.

In some cases, for measuring when an ambient IoT device is determined as “near,” the ambient IoT device may be determined as “end-to-end near” if the receive reader measures the threshold of the received signals (e.g., a D2R preamble) above a certain threshold on the scheduled resources. Alternatively, the ambient IoT device may be determined as “R2D near,” if the receive reader receives the D2R preamble on the scheduled resources, but the measured strength is below a certain threshold.

In some embodiments, a determination of proximity of the ambient IoT device relative to transmit reader may be based on an “end-to-end” trip time. For example, a time of flight (e.g., the trip time) may be defined as a R2D trip time from the transmit reader to the ambient IoT device plus a processing delay margin at the ambient IoT device plus a D2R trip time from the ambient IoT device to the receive reader. The total time of flight may be used to determine the proximity for at least the transmit reader by comparing it against a threshold total flight time. If the calculated total flight time is less than the threshold total flight time, then at least the transmit reader is “near” to the ambient IoT device.

In some embodiments, a determination of proximity of the device relative to transmit reader may be based on a power control. For example, the transmit reader may be configured with two levels of transmit power P_{high} and P_{low} (within the maximum transmit power limit Pmax) and if the receive reader is able to receive a response from the ambient IoT device to the corresponding query transmitted by transmit reader to the ambient IoT device at P_{high}, then the ambient IoT device may be determined as “near” to at least the receive reader. If the receive reader is not able to receive a response from the ambient IoT device to the corresponding query transmitted by transmit reader to the ambient IoT device at P_{high}, then the ambient IoT device may be determined as “not near” to either the receive reader or transmit reader.

Additionally, in a second round of communication, if the receive reader is able to receive a response from the ambient IoT device to the corresponding query transmitted by transmit reader to the ambient IoT device at P_{low}, then the ambient IoT device may be determined as “near” to also the transmit reader. Further in the second round of communication, if the receive reader is not able to receive a response from the ambient IoT device to the corresponding query transmitted by transmit reader to the ambient IoT device at P_{low}, then the ambient IoT device may be determined as “not near” to the transmit reader.

In some cases, if the measured strength of the response (including at least the preamble) from the ambient IoT device is above a certain threshold at the receive reader to the corresponding query transmitted by transmit reader to the ambient IoT device at P_{high}, then the ambient IoT device may be determined as “near” to at least the receive reader. Similarly for the second round, a measurement threshold (may be same or different as compared to the first round) may be measured at the receive reader to determine the proximity of the transmit reader based on transmission at P_{low}.

In some embodiments, a determination of whether a separate receive reader is needed or not may be introduced. For example, the transmit reader may be configured as a receive reader, if the same reader is able to successfully receive the response corresponding to query transmitted. If no response is detected on the scheduled resources, then the reader may not be suitable for being configured as a transmit reader. If a response is detected on the scheduled resources, but is not successfully detected, then it may be determined that the reader may be suitable as a transmit reader only, but not as a receive reader.

In some cases, if the response is received, but the signal strength is below a certain threshold, then it may be determined that the reader may be suitable as a transmit reader only, but not as a receive reader. Further, if the response is received and also the signal strength is above a certain threshold, than the same reader may be configured as both a transmit reader and a receive reader as it may be determined that the reader may be suitable as a transmit reader and as a receive reader.

By way of example embodiments, a first example (Example 1) is a method at a first device, the first device is determined to be “end-to-end near” to a second device if the first device transmits to the second device and is able to satisfy a “first receive condition” for the corresponding response from the second device, or “R2D near” to a second device if the first device transmits to the second device and is able to satisfy a “second first receive condition” for the corresponding response from the second device, or “D2R near” to a second device if a third device transmits to the second device and the first device is able to satisfy a “first receive condition” for the corresponding response from the second device.

Example 2 includes the method of Example 1, wherein the first device is network node, and the third device is also a different network node.

Example 3 includes the method of Example 1, wherein the first device is network node, and the third device is a user device node.

Example 4 includes the method of Example 1, wherein the first device is a user device node, and the third device is a network node.

Example 5 includes the method of Example 1, wherein the first device is a user device node, and the third device is also a different user device node.

Example 6 includes the method of Example 1, wherein the “first receive condition” means to successfully receive and decode the response from the second device.

Example 7 includes the method of Example 1, wherein the “first receive condition” means to receive the response on the scheduled resources, measure the signal strength of the response and compare against the pre-configured threshold to be greater.

Example 8 includes the method of Example 1, wherein the “second condition” means to receive the response on the scheduled resources, but not able to successfully decode it.

Example 9 includes the method of Example 1, wherein the “second condition” means to receive the response on the scheduled resources, measure the signal strength of the response and compare against the pre-configured threshold to be lesser.

Example 10 includes the method of Example 1, wherein the nearness of second device to at least first device is determined based on the total flight time to be less than the pre-configure threshold for total flight time, wherein the total flight time is determined based on the propagation delay from first device to second device, processing time at the second device and the propagation delay from the second device to the third device.

Example 11 includes the method of Example 10, wherein the total flight time is determined at the third device and the first device receives information either directly or indirectly from the third device to determine whether the second device is near.

Example 12 includes the method of Example 1, wherein the first device determines the nearness of second device based on at least two transmissions to the second device, wherein the first transmission is done at a higher power level and the second transmission is done at a lower power level and the reception of the response from the second device corresponding to the two transmission to the second device is done at the third device.

Example 13 includes the method of Example 12, wherein if the third device is able to receive the response from the second device for both the transmissions according to the “first receive condition”, then the second device is determined as near to at least the first device.

Proximity Determination for Ambient IoT Devices with Topology 2

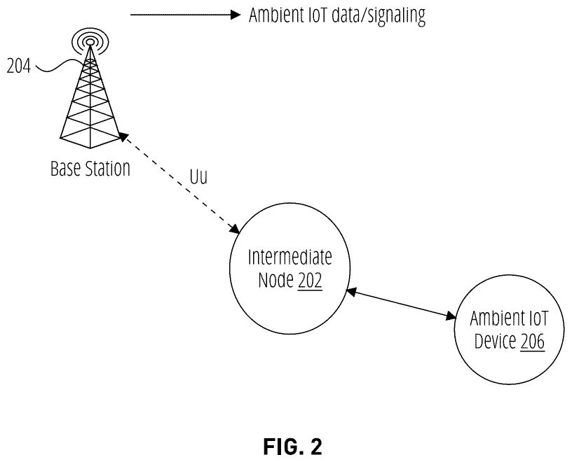

FIG. 2 illustrates an example of Topology 2. In some wireless communication systems, for ambient IoT device communication, two topologies have been considered. The deployment scenarios of the two topologies may include various characteristics. (as further detailed in the tables of clause 4.2.2 of 3GPP technical report (TR) 38.848 Version 18.0.0 Dated September 2023). For example, a first deployment scenario, according to Topology 1, may include a base station with various coexistence characteristics such as micro-cell and co-site characteristics. A second deployment scenario, according to Topology 2, may include an intermediate node 202, that may be configured and signaled to by a base station 204 (e.g., under network control) to communicate with an ambient IoT device 206. The intermediate node 202 may comprise, for example, a UE or other device configured to communicate with the base station 204 and/or the ambient IoT device 206.

The base station 204 signals, to the intermediate node 202, via a Uu link (e.g., a communication interface between the base station and the UE). Accordingly, the intermediate node 202 may signal, to the ambient IoT device 206, various configurations, settings and/or other information without the ambient IoT device 206 communicating with the base station 204. Further, Topology 2 may include a base station 204 with various coexistence characteristics such as macro-cell and co-site characteristics. The location of the intermediate node 202 may be indoors. Additionally, for a second deployment scenario, with Topology 2, the intermediate node 202 may act as the reader for the ambient IoT device 206, but may still be that the intermediate node 202 may be controlled by the base station 204. In Topology 2, the ambient IoT device 206 may communicate bidirectionally with the intermediate node 202 between the ambient IoT device 206 and the base station 204. Accordingly, the intermediate node 202 may transfer the ambient IoT device 206 data and/or signaling between the base station 204 and the ambient IoT device 206.

It should be understood that various issues may be encountered while performing communication with ambient IoT devices in Topology 2 where an intermediate node (e.g., an intermediate UE) may be deployed to communicate with the ambient IoT device(s), where the intermediate node is under the control of/configured by network (e.g., the network may communicate to the intermediate node on how, when, and what to communicate with the ambient IoT device).

Additionally, in some wireless communication systems, for ambient IoT device communication, various details may be considered related to proximity determination of the ambient IoT devices. For example, for ambient IoT devices, a proximity determination may be defined as a calculation of a relative distance between the reader and the ambient IoT device, however it may be beneficial to define and/or consider a target accuracy. Further, the proximity determination may be defined as a calculation of a binary distance between the reader and the ambient IoT device (i.e., whether they are “near” or “far”), however it may be beneficial to further consider details on how to define/determine “near” and “far.” Note that, for ambient IoT devices, the proximity determination may be done at either only the reader side (base station and/or intermediate UE) or at either the reader side or the ambient IoT device side.

Additionally, in some wireless communication mechanisms, based on discussions in 3GPP, it may be that proximity determination may be based on measurements primarily at the reader side. In addition, some assistance from the ambient IoT device may be considered (e.g., reference signal measurements, such as a preamble reference signal received power (RSRP)). The proximity determination may be done at the reader. Furthermore, for the proximity determination, instead of determining a specific location or range of the device relative to reader, it may be that a binary determination such as “near” or “far” may be considered.

Embodiments herein discuss a proximity determination for Topology 2 where the network may communicate with the ambient IoT device via an intermediate UE. In such scenarios (e.g., Topology 2), various design aspects for the intermediate UE may need to be considered to assist with proximity determination of the ambient IoT device. For example, embodiments herein discuss details on how the network may determine which UEs may be utilized for communication with ambient IoT device based on proximity determination, how an intermediate UE may determine the proximity of one or multiple ambient IoT devices, and/or how an intermediate UE may inform the network on whether and what ambient IoT devices are in its proximity and whether it can serve those ambient IoT devices.

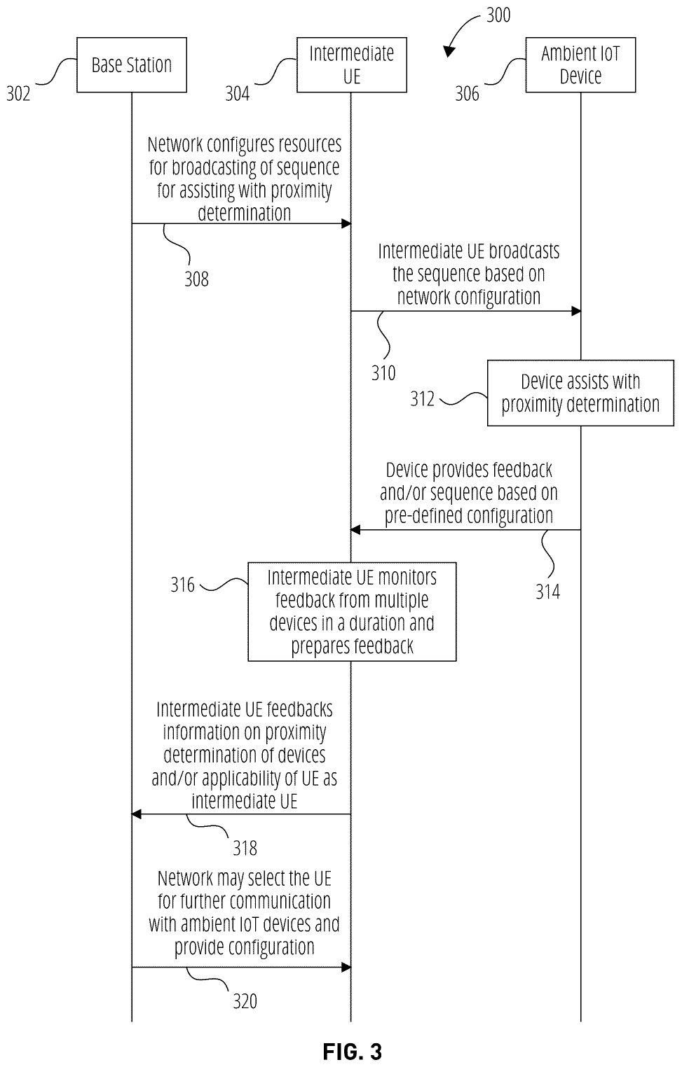

FIG. 3 illustrates a flow diagram 300 of a selection procedure to determine intermediate UE(s) for communication with an ambient IoT device, according to embodiments herein.

In various embodiments, a selection procedure may be introduced and specified to determine the intermediate UEs for communication with the ambient IoT device and/or for carrier wave transmission. A flow diagram 300 of the procedure begins with the base station 302 (e.g., the network configuring 308 multiple intermediate UEs 304 to broadcast a sequence or a reference signal to ambient IoT devices 306 (first step). The intermediate UE 304 may broadcast 310 the sequence based on the base station 302 configuration.

Then, the ambient IoT device 306 may assist 312 with proximity determination (second step) by performing an energy detection threshold of the sequence and reporting back to the intermediate UE 304 whether it (the ambient IoT device) is “near” or “far” relative to the intermediate UE 304 and may associate its ambient IoT device 306 identifier (ID) or temporary device identifier. In some other cases, the ambient IoT device 306 may assist 312 with the proximity determination by not performing energy detection, but rather by responding back with a sequence and a device ID or temporary device identifier. Subsequently, the intermediate UE 304 may determine the proximity based on an indication 314 (e.g., feedback) of “near” or “far” from the ambient IoT device 306 or may perform a measurement of the transmitted sequence from the device (third step).

Then, the intermediate UE 304 may perform 316 proximity determination for multiple ambient IoT devices 306 within a configured duration. This may include the intermediate UE 304 monitoring feedback from multiple ambient IoT devices 306 in a duration and preparing feedback (fourth step).

Accordingly the intermediate UE 304 may provide 318 feedback to the base station 302. The feedback may include an indication of whether a UE may be suitable to serve as an intermediate UE 304 for communication with the ambient IoT device 306 (or not) which may be based on pre-configured threshold in terms of the number of ambient IoT devices 306 that are determined in “near” proximity (e.g., if the number of devices are less than pre-configured threshold “X”). The UE may indicate it non-suitability, or the UE may indicate its suitability. The feedback may, in some cases, also include an indication of the list of ambient IoT devices (including the device ID or the temporary identifier) to the base station 302 that may be determined to be in “near” proximity (fifth step). Subsequently, in response to the base station 302 receiving the feedback, accordingly, the base station 302 may configure 320 a subset of the UEs for serving as an intermediate UE 304 for communication with ambient IoT devices 306. It may be reported in UE capability whether the UE may be capable or not as to supporting and/or being able to communicate with ambient IoT devices 306.

In various embodiments, the network may dynamically signal and/or request a group of UEs (e.g., via groupcast downlink control information (DCI) format 2_X) to broadcast sequence(s) and/or reference signal(s) to assist with the proximity determination and consequently determine whether the responding UE(s) may be configurable as an intermediate UE or not. In some cases, in the groupcast DCI, the network may include information such as at least time resources and power control parameters. In some other cases, the groupcast DCI may include repetition of the broadcast sequence(s) and/or the reference signal(s).

In various embodiments, the network may dynamically signal a group of UEs (e.g., via groupcast DCI format 2_X) to activate semi-statically configured broadcast sequence(s) and/or reference signal(s) to assist with the proximity determination and consequently to determine whether the responding UE(s) may be configurable as an intermediate UE or not. In some cases, in the groupcast DCI, the network may send an activation command, based on which of the UEs may start broadcasting the sequence(s) and/or the reference signal(s). In some examples, the UE may continue with broadcasting the sequence(s), until a deactivation command is sent, while in some other examples, in the groupcast DCI, in addition to an activation command, a duration may be indicated, for which the response from the ambient IoT devices may be considered.

In various embodiments, the ambient IoT device may receive sequence(s) and/or reference signal(s) from one or multiple intermediate UEs, which may further assist with the proximity determination. In the case of multiple receptions, an ambient IoT device may perform energy detection threshold comparisons on all receptions, but may respond back corresponding to the strongest reception with a corresponding “near” or “far” as an outcome of proximity determination. Alternatively, in the case of multiple receptions, an ambient IoT device may perform energy detection threshold comparisons on all receptions, and may respond back corresponding to all the receptions with a corresponding “near” or “far” as an outcome of the proximity determination. In the case of multiple receptions, an ambient IoT device may not perform any detection threshold comparisons and may respond corresponding to only the first receptions if it correctly receives the known sequence(s) and/or reference signal(s). Alternatively, in the case of multiple receptions, an ambient IoT device may not perform any detection threshold comparisons and may respond corresponding to all the receptions if it correctly receives the known sequence(s) and/or reference signal.

In some such embodiments, depending on the type of ambient IoT device, a specific procedure (discussed herein) may be applied. For example, for “Device 1” discussed herein (low category), a threshold detection based procedure may not be applied, while, for “Device 2a” or “Device 2b” discussed herein (higher category), either of a threshold detection procedure or a response with sequence procedure may be utilized.

In various embodiments, the UE may be configured by the network to determine the proximity for multiple ambient IoT devices within a fixed duration and interval, where the proximity determination may either based on direct reporting of “near” or “far” from the ambient IoT device or based on a measurement of received sequence(s) and/or reference signal(s) from the device. For example, in the cases of a procedure based on a measurement of received sequence(s) from the ambient IoT device, a pre-configured threshold may be applied to determine if the corresponding device is “near” or “far”. Then, for the duration of interval, the intermediate UE may at least determine the number of devices that may be determined as “near”. Additionally, the intermediate UE may determine the number of devices that may be determined as “far”. Further, based on the determination, the UE may recommend whether it is suitable or not to operate as an intermediate UE. Note that this may be based on a pre-defined threshold in terms of the number of minimum devices that may be determined as “near.” Once the UE is determined as “suitable” or “not suitable,” it may remain in the same state, unless a second round of determination is triggered by the network in the case of dynamic indication or in the next period in the case of periodic or semi-static configuration.

In various embodiments, the intermediate UE(s) may be configured with a single uplink resource (e.g., single physical uplink control channel (PUCCH) resource) to indicate the feedback to the network related to determination as “suitable” or “not suitable” for communicating with the ambient IoT device or providing statistics of the ambient IoT devices including the proximity determination and a corresponding device ID. In some cases, a value of “0” may be used to indicate “not suitable” and a value of “1” may be used to indicate “suitable”. Note that the uplink control information (UCI) may be enhanced to include this reporting quantity. In some other cases, a PUCCH may be used for transmitting feedback in the case of when the intermediate UE is only configured to report “suitable” or “not suitable” and the physical uplink shared channel (PUSCH) is used for transmitting the feedback in cases when the intermediate UE is configured to provide statistics of the ambient IoT devices including the proximity determination and a corresponding device ID.

In various embodiments, the intermediate UE(s) may be configured with multiple uplink resources (e.g., multiple PUCCH resources) to indicate the feedback to the network corresponding to each of the responses (e.g., when the UE may transmit a sequence to an ambient IoT device), indicating that there may be a corresponding PUCCH resource. In some such embodiments, the feedback transmitted, from the UE to the network, may include a device ID and a corresponding determination as “near” or “far” for each PUCCH resource. In the feedback, a value of “0” may be used to indicate “far” and a value of “1” may be used to indicate “near.”

### Signaling for Intermediate UEs for Ambient IoT Device Communication

In some wireless communication systems, for Topology 2, intermediate UE behavior and related signaling between the UE and the base station may be contemplated and specified to support network-controlled communication with ambient IoT device(s) via the intermediate UE. In some mechanism, the intermediate UE may need to perform, decode, and forward a function for forwarding R2D and D2R because of different physical layer (PHY) design aspects between the link from the base station to/from the UE and the UE to/from the ambient IoT device.

Embodiments herein discuss details on intermediate UE behavior if no response is received from the ambient IoT device(s) (e.g., based on the command/query sent to ambient IoT device(s)), handling forwarding between the intermediate UE and the ambient IoT device for coverage extension and/or no response, and supporting link adaptation for the intermediate UE to ambient IoT device link for R2D forwarding.

In various embodiments, when the intermediate UE is configured/scheduled/signaled by the network (e.g., by the base station) to receive a response/data from an ambient IoT device on the scheduled resources and if no response is received and/or detected by the intermediate UE, then the intermediate UE may be expected to send an explicit negative acknowledgment (NACK) message to the base station. In some cases, for transmission of the NACK message to the base station, various options may be applied. In a first option, the NACK message may be multiplexed on the PUCCH and/or PUSCH resources with other UCI that may or may not be related to ambient IoT device. In a second option, the NACK message may be sent on dedicated resources for forwarding information related to ambient IoT device. In some such options, the resources configured to the intermediate UE for forwarding of D2R data from the UE to the base station may be used for sending the NACK message in case there may be no response received. Note that various combinations of the first and second options may be used for transmission of the NACK message.

In various embodiments, when the intermediate UE is configured/scheduled/signaled by the network (e.g., by the base station) to receive a response/data from an ambient IoT device on the scheduled resources and if no response is received and/or detected by the intermediate UE, then the intermediate UE may provide an implicit NACK message by not forwarding anything on the resources that the intermediate UE may be scheduled/configured with for forwarding the D2R response back to base station. In some cases, when the base station does not receive any D2R response when expected on the scheduled/configured resources, then the base station may assume that the intermediate UE did not receive the response.

In various embodiments, a one-hop repetition may be introduced, where the network may configure/signal the intermediate UE to perform repetition of the R2D transmission to the ambient IoT device, instead of having end-to-end repetition of the R2D from the base station to the intermediate UE and further to the ambient IoT device. To start, the base station may configure the intermediate UE with a one-hop repetition mode, including one or more of the number of repetitions, the corresponding resources, and the conditions under which repetitions are transmitted (first step). Then, the base station may transmit R2D data to the intermediate UE for forwarding to the ambient IoT device (second step). Subsequently, the intermediate UE may perform the first transmission/forwarding to the ambient IoT device (third step), and based on the base station configuration, the UE may perform repetition for the R2D forwarding (fourth step).

In some embodiments, for the one-hop repetition procedure, the intermediate UE may be configured by the base station to perform repetition only when a response is not received from the ambient IoT device on the configured/scheduled resources for D2R. If the response is received from the ambient IoT device then, the intermediate UE may not be required to repeat the same R2D transmission for which the response is already received. Various options may be introduced for the repetition behavior at the intermediate UE. In a first option, the intermediate UE may perform the repetition and may wait for a response and if no response is received on the configured/scheduled resources, then only the next repetition is performed. This behavior may continue until the maximum number of repetitions are exhausted.

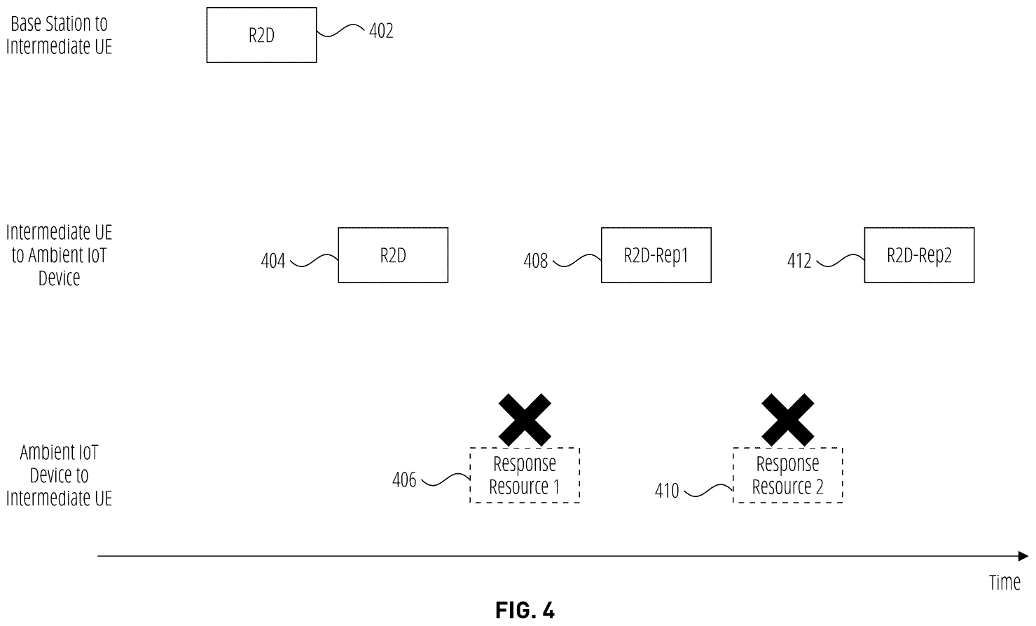

FIG. 4 illustrates an example of a repetition procedure where only a next repetition is performed after a response is not received, according to embodiments herein. For example, R2D data 402 may be forwarded (e.g., transmitted) from the base station to the intermediate UE. Then, the intermediate UE may forward the R2D data 404 to the ambient IoT device. If no response is received 406 from the ambient IoT device, the intermediate UE may transmit a first R2D data repetition 408 of the R2D data to the ambient IoT device. If no response is received 410 again from the ambient IoT device, the intermediate UE may transmit a second R2D data repetition 412 of the R2D data 402 to the ambient IoT device.

In a second option, the intermediate UE may perform multiple repetitions and no response may be received for the first transmission on the configured/scheduled resources. In some instances, a combination of both the first option and second option may be implemented.

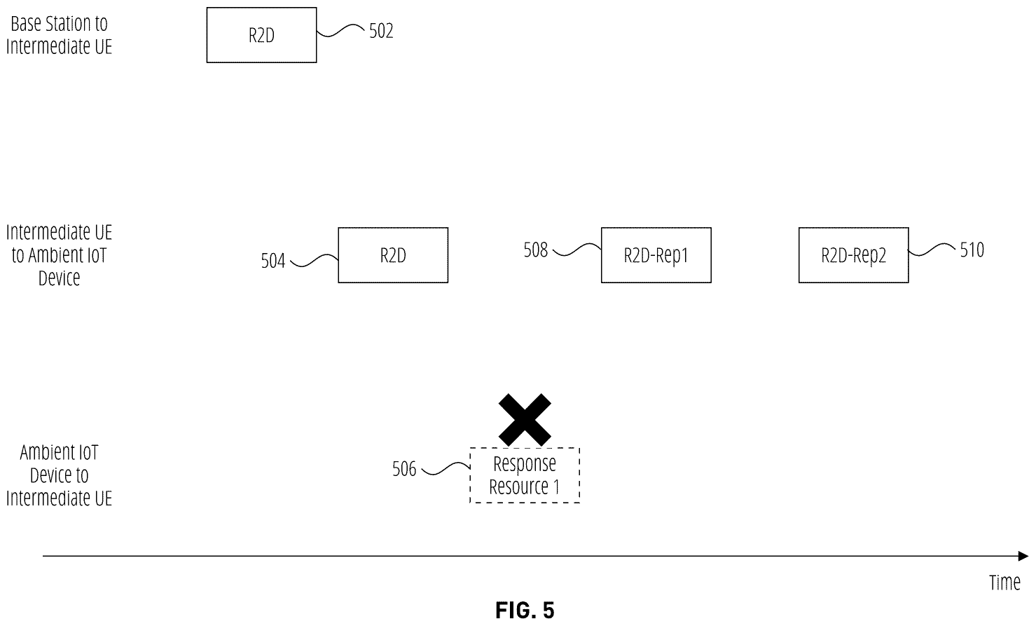

FIG. 5 illustrates an example of a repetition procedure where multiple repetitions are performed after a response is not received, according to embodiments herein. For example, R2D data 502 may be forwarded (e.g., transmitted) from the base station to the intermediate UE. Then, the intermediate UE may forward the R2D data 504 to the ambient IoT device. If no response is received 506 from the ambient IoT device, the intermediate UE may transmit a first R2D data repetition 508 of the R2D data and a second R2D data repetition 510 of the R2D data to the ambient IoT device.

Additionally, various options may be introduced for forwarding the response from the intermediate UE to the base station, in terms of resource configuration/scheduling. In a first option, a single resource may be configured corresponding to the multiple repetition occasions. In a second option, a one-to-one resource for forwarding may be configured corresponding to each of the repetition occasion in case of the first option for repetition. In some instances, a combination of the first option and the second option may be implemented.

Further, it should be understood that, in some cases, the repetition based procedure may be used in combination with the NACK message based procedure(s) discussed herein. In some examples, the NACK message may be sent only once, after all repetitions are exhausted at the intermediate UE. In some other examples, the NACK message may be sent corresponding to each repetition.

In various embodiments, for the one-hop procedure, an intermediate UE may be configured by the base station to perform repetition independent of whether the response is received or not from the ambient IoT device on the configured/scheduled resources for D2R. In some cases, the intermediate UE may be configured with resources for multiple back-to-back repetitions (e.g., contiguous and/or non-contiguous) for R2D forwarding to the ambient IoT device. In some other cases, the intermediate UE may be configured with an at least one resource corresponding to the response forwarding to the base station (i.e., one response corresponding to all the repetitions) where the resource for response forwarding comes after the resources of all repetitions. Note that such repetition based procedure(s) may be used in combination with the NACK message based procedure(s) discussed herein. For example, the NACK message may be sent only once after all repetitions are exhausted at the intermediate UE.

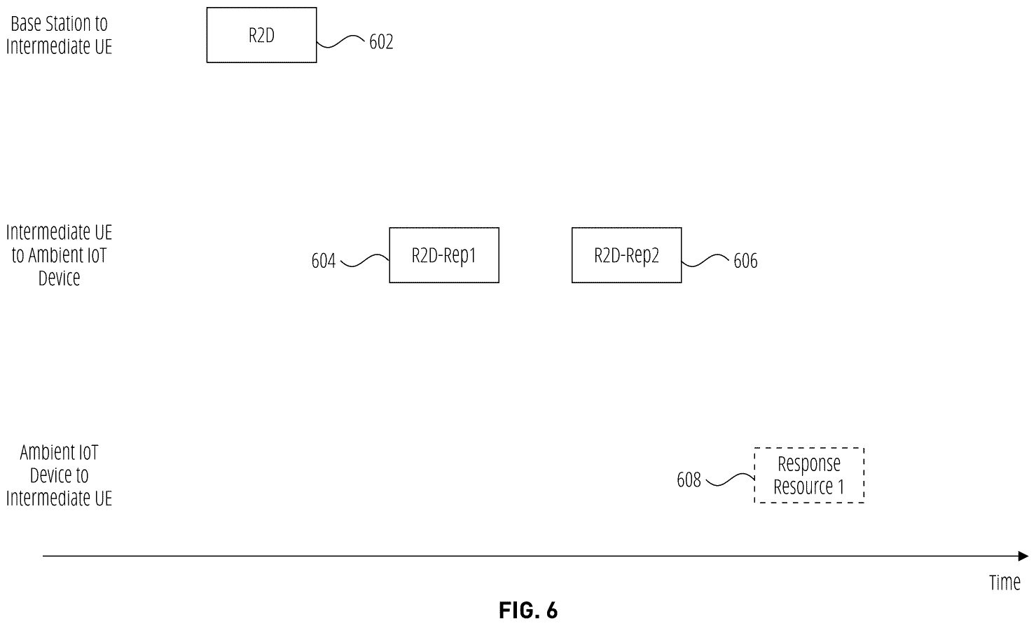

FIG. 6 illustrates an example of a repetition procedure where the repetitions are performed independent of whether a response is received or not, from an ambient IoT device, according to embodiments herein. For example, the base station may forward (e.g., transmit) R2D data 602 to the intermediate UE. Then, the intermediate UE forwards both a first R2D data repetition 604 and a second R2D data repetition 606 to the ambient IoT device. The number of repetitions may be configured by the network. Accordingly, the ambient IoT device may transmit a response resource 608 to the intermediate UE once the repetitions are received by the ambient IoT device.

In various embodiments, for a one-hop repetition procedure, an intermediate UE may be configured by the base station to perform repetition, where a transmission parameter between two repetitions may be different. In some cases, if multiple code rates are supported by the ambient IoT device for receiving R2D within an inventory/communication round, then a first set of repetitions may be configured with a coding rate “R” and a second set of repetitions maybe configured with coding rate “R”/2. In some cases, if multiple coding schemes are supported by the ambient IoT device for receiving R2D within an inventory/communication round, then a first set of repetitions may be configured with coding scheme one (e.g., pulse-interval encoding (PIE) coding) and a second set of repetitions maybe configured with coding scheme two (e.g., Manchester coding). In some cases, if multiple modulation schemes are supported by the ambient IoT device for receiving R2D within an inventory/communication round, then a first set of repetitions may be configured with modulation scheme one (e.g., OOK-1) and a second set of repetitions may be configured with modulation scheme two (e.g., OOK-4). Further, various combinations of the discussed cases may be used for determining transmission parameters between two repetitions that may be different.

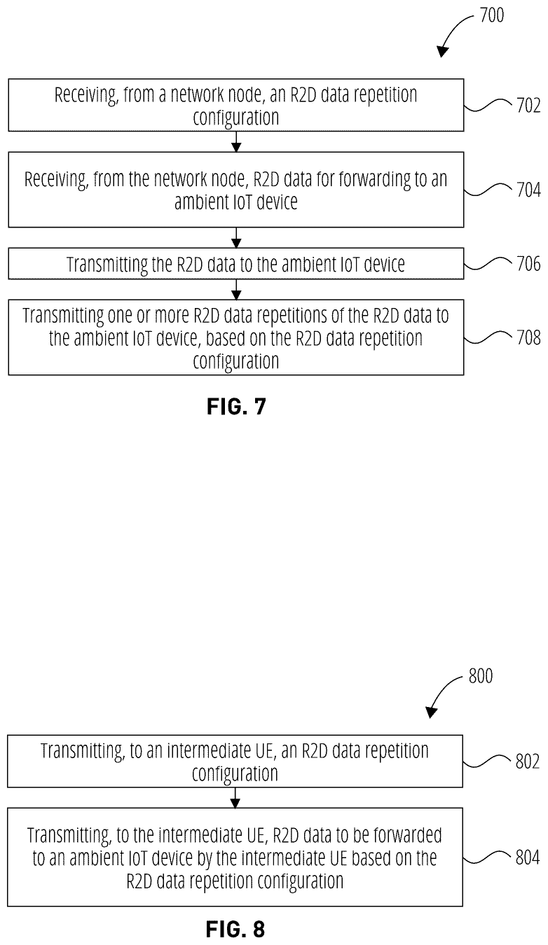

FIG. 7 illustrates a method 700 for an intermediate UE, according to embodiments herein. The illustrated method 700 includes receiving 702, from a network node, an R2D data repetition configuration. The method 700 further includes receiving 704, from the network node, R2D data for forwarding to an ambient IoT device. The method 700 further includes transmitting 706 the R2D data to the ambient IoT device. The method 700 further includes transmitting 708 one or more R2D data repetitions of the R2D data to the ambient IoT device, based on the R2D data repetition configuration.

In some embodiments of the method 700, transmitting the one or more R2D data repetitions comprises: transmitting a single R2D data repetition to the ambient IoT device each time a response from the ambient IoT device for a transmission is not received on a configured resource until a maximum number of repetitions is reached.

In some embodiments of the method 700, transmitting the one or more R2D data repetitions comprises: transmitting a plurality of R2D data repetitions to the ambient IoT device in response to determining that a response to the R2D data is not received.

In some embodiments, the method 700 further comprises receiving, from a network node, a resource configuration comprising a single resource for forwarding a response from the ambient IoT device corresponding to a plurality of repetition occasions of the one or more R2D data repetitions, receiving the response from the ambient IoT device, and transmitting the response to the network node on the single resource.

In some embodiments, the method 700 further comprises receiving, from a network node, a resource configuration comprising multiple resources, wherein the multiple resources correspond to repetition occasions of the one or more R2D data repetitions in a one-to-one manner, receiving a response from the ambient IoT device, and transmitting the response to the network node on the multiple resources.

In some embodiments of the method 700, the R2D data repetition configuration configures the intermediate UE to transmit the one or more R2D data repetitions to the ambient IoT device independent of whether a response is received from the ambient IoT device, wherein the R2D data repetition configuration configures the intermediate UE with one or more resources for response forwarding to the network node.

In some embodiments of the method 700, a first set of the one or more R2D data repetitions corresponds to a first coding rate and a second set of the one or more R2D data repetitions corresponds to a second coding rate.

In some embodiments of the method 700, a first set of the one or more R2D data repetitions corresponds to a first coding scheme and a second set of the one or more R2D data repetitions corresponds to a second coding scheme.

In some embodiments of the method 700, a first set of the one or more R2D data repetitions corresponds to a first modulation scheme and a second set of the one or more R2D data repetitions corresponds to a second modulation scheme.

In some embodiments, the method 700 further comprises determining that no response is received from the ambient IoT device, and transmitting, to the network node, a NACK message, wherein the NACK message is multiplexed on or both of PUCCH and PUSCH resources with UCI.

In some embodiments, the method 700 further comprises determining that no response is received from the ambient IoT device, and transmitting, to the network node, a NACK message, wherein the NACK message comprises a dedicated resource for forwarding information to the network node related to the ambient IoT device.

FIG. 8 illustrates a method 800 for a network node, according to embodiments herein. The illustrated method 800 includes transmitting 802, to an intermediate UE, an R2D data repetition configuration. The method 800 further includes transmitting 804, to the intermediate UE, R2D data to be forwarded to an ambient IoT device by the intermediate UE based on the R2D data repetition configuration.

In some embodiments of the method 800, the R2D data repetition configuration configures the intermediate UE to transmit a single R2D data repetition to the ambient IoT device each time a response from the ambient IoT device for a transmission is not received on a configured resource until a maximum number of repetitions is reached.

In some embodiments of the method 800, the R2D data repetition configuration configures the intermediate UE to transmit a plurality of R2D data repetitions to the ambient IoT device in response to determining that a response to the R2D data is not received.

In some embodiments, the method 800 further comprises transmitting, to the intermediate UE, a resource configuration comprising a single resource for forwarding a response from the ambient IoT device corresponding to a plurality of repetition occasions of the one or more R2D data repetitions, and receiving, from the intermediate UE, a response from the ambient IoT device on the single resource.

In some embodiments, the method 800 further comprises transmitting, to the intermediate UE, a resource configuration comprising multiple resources, wherein the multiple resources correspond to repetition occasions of the one or more R2D data repetitions in a one-to-one manner, and receiving, from the intermediate UE, a response from the ambient IoT device on the multiple resources.

In some embodiments of the method 800, the R2D data repetition configuration configures the intermediate UE to transmit the one or more R2D data repetitions to the ambient IoT device independent of whether a response is received from the ambient IoT device, wherein the R2D data repetition configuration configures the intermediate UE with one or more resources for response forwarding to the network node.

In some embodiments of the method 800, the R2D data repetition configuration comprises at least one of: a first set of one or more R2D data repetitions corresponding to a first coding rate and a second set of one or more R2D data repetitions corresponding to a second coding rate, a first set of one or more R2D data repetitions corresponding to a first coding scheme and a second set of one or more R2D data repetitions corresponding to a second coding scheme, and a first set of one or more R2D data repetitions corresponding to a first modulation scheme and a second set of one or more R2D data repetitions corresponding to a second modulation scheme.

In some embodiments, the method 800 further comprises receiving, from the intermediate UE, a NACK message, wherein the NACK message is multiplexed on or both of PUCCH and PUSCH resources with UCI or the NACK message comprises a dedicated resource for forwarding information to the network node related to the ambient IoT device.

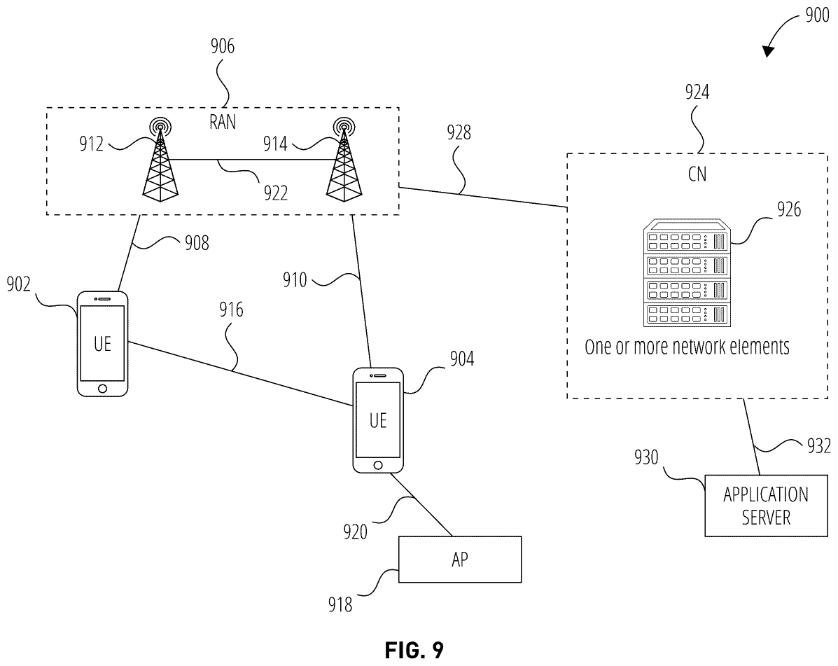

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VOIP sessions, group communication sessions, etc.) for the UE 902 and UE 904 via the CN 924. The application server 930 may communicate with the CN 924 through an IP communications interface 932.

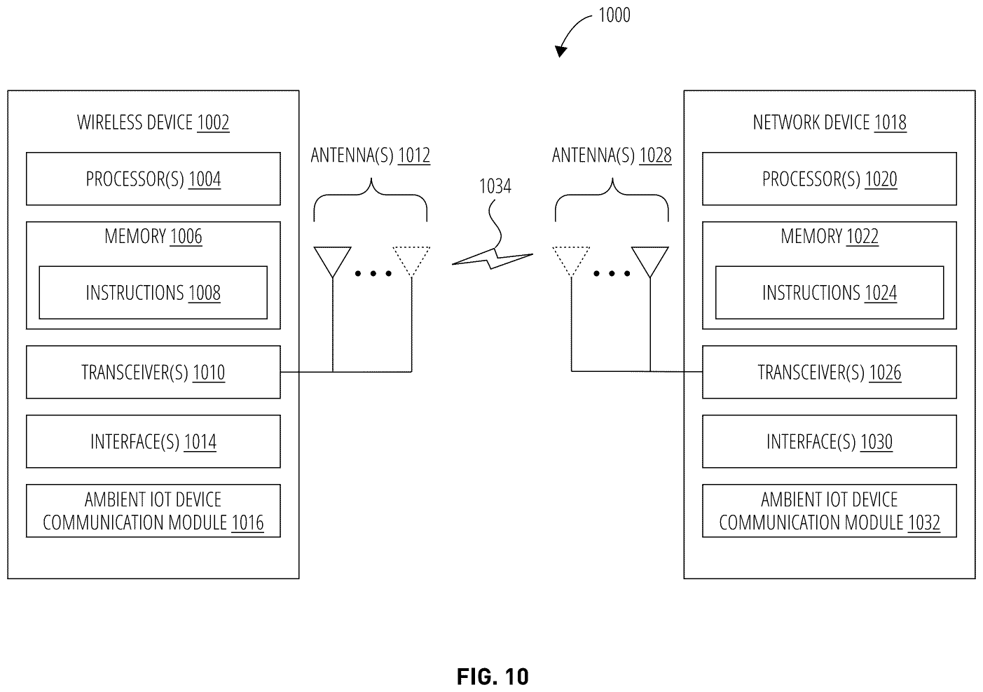

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter circuitry and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include an ambient IoT device communication module 1016. The ambient IoT device communication module 1016 may be implemented via hardware, software, or combinations thereof. For example, the ambient IoT device communication module 1016 may be implemented as a processor, circuit, and/or instructions 1008 stored in the memory 1006 and executed by the processor(s) 1004. In some examples, the ambient IoT device communication module 1016 may be integrated within the processor(s) 1004 and/or the transceiver(s) 1010. For example, the ambient IoT device communication module 1016 may be implemented by a combination of software components (e.g., executed by a DSP or a general processor) and hardware components (e.g., logic gates and circuitry) within the processor(s) 1004 or the transceiver(s) 1010.

The ambient IoT device communication module 1016 may be used for various aspects of the present disclosure, for example, aspects of FIG. 1A, FIG. 1B, FIG. 2, FIG. 3, FIG. 4, FIG. 5, FIG. 6, FIG. 7, FIG. 9 and FIG. 10. The ambient IoT device communication module 1016 may be configured to cause the wireless device 1002 to receive, from a network device 1018, an R2D data repetition configuration. The ambient IoT device communication module 1016 may be configured to further cause the wireless device 1002 to receive, from the network device 1018, R2D data for forwarding to an ambient IoT device. The ambient IoT device communication module 1016 may be configured to further cause the wireless device 1002 to transmit the R2D data to the ambient IoT device. The ambient IoT device communication module 1016 may be configured to further cause the wireless device 1002 to transmit one or more R2D data repetitions of the R2D data to the ambient IoT device, based on the R2D data repetition configuration.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter circuitry and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include an ambient IoT device communication module 1032. The ambient IoT device communication module 1032 may be implemented via hardware, software, or combinations thereof. For example, the ambient IoT device communication module 1032 may be implemented as a processor, circuit, and/or instructions 1024 stored in the memory 1022 and executed by the processor(s) 1020. In some examples, the ambient IoT device communication module 1032 may be integrated within the processor(s) 1020 and/or the transceiver(s) 1026. For example, the ambient IoT device communication module 1032 may be implemented by a combination of software components (e.g., executed by a DSP or a general processor) and hardware components (e.g., logic gates and circuitry) within the processor(s) 1020 or the transceiver(s) 1026.

The ambient IoT device communication module 1032 may be used for various aspects of the present disclosure, for example, aspects of FIG. 1A, FIG. 1B, FIG. 2, FIG. 3, FIG. 4, FIG. 5, FIG. 6, FIG. 8, FIG. 9 and FIG. 10. The ambient IoT device communication module 1032 may be configured to cause the network device 1018 to transmit, to a wireless device 1002 an R2D data repetition configuration. The ambient IoT device communication module 1032 may be configured to further cause the network device 1018 to transmit, to the wireless device 1002, R2D data to be forwarded to an ambient IoT device by the wireless device 1002 based on the R2D data repetition configuration.

Embodiments contemplated herein include an apparatus comprising means to perform one or more elements of the method 700. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 700. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 1002 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of the method 800. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the method 800. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1018 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an intermediate user equipment (UE), comprising:
receiving, from a network node, a reader-to-device (R2D) data repetition configuration;
receiving, from the network node, R2D data for forwarding to an ambient internet of things (IoT) device;
transmitting the R2D data to the ambient IoT device; and
transmitting one or more R2D data repetitions of the R2D data to the ambient IoT device, based on the R2D data repetition configuration.

2. The method of claim 1, wherein transmitting the one or more R2D data repetitions comprises:
transmitting a single R2D data repetition to the ambient IoT device each time a response from the ambient IoT device for a transmission is not received on a configured resource until a maximum number of repetitions is reached.

3. The method of claim 1, wherein transmitting the one or more R2D data repetitions comprises: transmitting a plurality of R2D data repetitions to the ambient IoT device in response to determining that a response to the R2D data is not received.

4. The method of claim 1, further comprising:
receiving, from a network node, a resource configuration comprising a single resource for forwarding a response from the ambient IoT device corresponding to a plurality of repetition occasions of the one or more R2D data repetitions;
receiving the response from the ambient IoT device; and
transmitting the response to the network node on the single resource.

5. The method of claim 1, further comprising:
receiving, from a network node, a resource configuration comprising multiple resources, wherein the multiple resources correspond to repetition occasions of the one or more R2D data repetitions in a one-to-one manner;
receiving a response from the ambient IoT device; and
transmitting the response to the network node on the multiple resources.

6. The method of claim 1, wherein the R2D data repetition configuration configures the intermediate UE to transmit the one or more R2D data repetitions to the ambient IoT device independent of whether a response is received from the ambient IoT device, wherein the R2D data repetition configuration configures the intermediate UE with one or more resources for response forwarding to the network node.

7. The method of claim 1, wherein a first set of the one or more R2D data repetitions corresponds to a first coding rate and a second set of the one or more R2D data repetitions corresponds to a second coding rate.

8. The method of claim 1, wherein a first set of the one or more R2D data repetitions corresponds to a first coding scheme and a second set of the one or more R2D data repetitions corresponds to a second coding scheme.

9. The method of claim 1, wherein a first set of the one or more R2D data repetitions corresponds to a first modulation scheme and a second set of the one or more R2D data repetitions corresponds to a second modulation scheme.

10. The method of claim 1, further comprising:
determining that no response is received from the ambient IoT device; and
transmitting, to the network node, a negative acknowledgement (NACK) message, wherein the NACK message is multiplexed on or both of physical uplink control channel (PUCCH) and physical uplink shared channel (PUSCH) resources with uplink control information (UCI).

11. The method of claim 1, further comprising:
determining that no response is received from the ambient IoT device; and
transmitting, to the network node, a negative acknowledgement (NACK) message, wherein the NACK message comprises a dedicated resource for forwarding information to the network node related to the ambient IoT device.

12. A method for a network node, comprising:
transmitting, to an intermediate user equipment (UE), a reader-to-device (R2D) data repetition configuration; and
transmitting, to the intermediate UE, R2D data to be forwarded to an ambient internet of things (IoT) device by the intermediate UE based on the R2D data repetition configuration.

13. The method of claim 12, wherein the R2D data repetition configuration configures the intermediate UE to transmit a single R2D data repetition to the ambient IoT device each time a response from the ambient IoT device for a transmission is not received on a configured resource until a maximum number of repetitions is reached.

14. The method of claim 12, wherein the R2D data repetition configuration configures the intermediate UE to transmit a plurality of R2D data repetitions to the ambient IoT device in response to determining that a response to the R2D data is not received.

15. The method of claim 12, further comprising:
transmitting, to the intermediate UE, a resource configuration comprising a single resource for forwarding a response from the ambient IoT device corresponding to a plurality of repetition occasions of the one or more R2D data repetitions; and
receiving, from the intermediate UE, a response from the ambient IoT device on the single resource.

16. The method of claim 12, further comprising:
transmitting, to the intermediate UE, a resource configuration comprising multiple resources, wherein the multiple resources correspond to repetition occasions of the one or more R2D data repetitions in a one-to-one manner; and
receiving, from the intermediate UE, a response from the ambient IoT device on the multiple resources.

17. The method of claim 12, wherein the R2D data repetition configuration configures the intermediate UE to transmit the one or more R2D data repetitions to the ambient IoT device independent of whether a response is received from the ambient IoT device, wherein the R2D data repetition configuration configures the intermediate UE with one or more resources for response forwarding to the network node.

18. The method of claim 12, wherein the R2D data repetition configuration comprises at least one of:
a first set of one or more R2D data repetitions corresponding to a first coding rate and a second set of one or more R2D data repetitions corresponding to a second coding rate,
a first set of one or more R2D data repetitions corresponding to a first coding scheme and a second set of one or more R2D data repetitions corresponding to a second coding scheme, and
a first set of one or more R2D data repetitions corresponding to a first modulation scheme and a second set of one or more R2D data repetitions corresponding to a second modulation scheme.

19. The method of claim 12, further comprising:
receiving, from the intermediate UE, a negative acknowledgement (NACK) message, wherein the NACK message is multiplexed on or both of physical uplink control channel (PUCCH) and physical uplink shared channel (PUSCH) resources with uplink control information (UCI) or the NACK message comprises a dedicated resource for forwarding information to the network node related to the ambient IoT device.

20. An intermediate user equipment (UE) apparatus, comprising:
a processor; and
a memory storing instructions that when executed by the processor, configure the intermediate UE apparatus to:
receive, from a network node, a reader-to-device (R2D) data repetition configuration;
receive, from the network node, R2D data for forwarding to an ambient internet of things (IoT) device;
transmit the R2D data to the ambient IoT device; and
transmit one or more R2D data repetitions of the R2D data to the ambient IoT device, based on the R2D data repetition configuration.
